(19) United States
(12) Patent Application Publication
(10) Pub. No.: US 2010/0142620 A1
(43) Pub. Date: Jun. 10, 2010

(54) METHOD OF GENERATING SIDE INFORMATION BY CORRECTING MOTION FIELD ERROR IN DISTRIBUTED VIDEO CODING AND DVC DECODER USING THE SAME

(75) Inventors: Mi Young LEE, Daejeon (KR); Han Jin CHO, Daejeon (KR)

Correspondence Address: AMPACC Law Group, 3500 188th Street S.W., Suite 103, Lynnwood, WA, 98037, US

(73) Assignee: Electronics and Telecommunications Research, Daejeon (KR)

(21) Appl. No.: 12/630,827

(22) Filed: Dec. 3, 2009

(30) Foreign Application Priority Data
Dec. 4, 2008 (KR) 10-2008-0122208
Nov. 19, 2009 (KR) 10-2009-0111878

(51) Int. Cl. H04N 7/26

(52) U.S. Cl. 375/240.16; 375/E07.104

(57) ABSTRACT

Disclosed is a technique that shifts the position of a motion compensation block by an error of a motion field and then performs motion compensation to estimate a current frame from past and future frames in digital video coding (DVC), thereby enhancing the accuracy of current frame estimation results.

### CROSS-REFERENCE TO RELATED APPLICATIONS

This application claims the priorities of Korean Patent Application Nos. 10-2008-0122208 filed on Dec. 4, 2008, and 10-2009-0111878 filed on Nov. 19, 2009, in the Korean Intellectual Property Office, the disclosures of which are incorporated herein by reference.

### BACKGROUND OF THE INVENTION

1. Field of the Invention

The present invention relates to a method of generating side information by correcting a motion field error in distributed video coding (DVC) and a DVC decoder using the same, and more particularly, to a technique that shifts the position of a motion compensation block by an error of a motion field and then performs motion compensation to estimate a current frame from past and future frames in DVC, thereby enhancing the accuracy of current frame estimation results.

2. Description of the Related Art

In general, unlike existing video coding algorithms, a DVC field requires a technique of estimating a current frame from past and future frames, without the presence of the current frame.

FIG. 1 is a conceptual view of general DVC in which a side information generation module of a DVC decoder estimates a current frame. As shown in FIG. 1, the side information generation module estimates the current frame upon receiving only previously decoded frames from a video merging module that stores the previously decoded frames.

In detail, the side information generation module performs motion estimation from a future frame closest to the current frame to the past frame closest to the current frame, and then performs bi-directional motion compensation according to a time difference ratio between the current frame, the future frame, and the past frame, thereby estimating the current frame.

In this process, when searching is performed from the future frame to the past frame based on blocks, a motion field is obtained from the future frame to the past frame. In this case, however, the motion field obtained thusly is not a motion field for the center of a block matched to the current frame, so the use of the result as a motion field of the block matched to the current frame would cause an error in the estimation of the current frame.

### SUMMARY OF THE INVENTION

An aspect of the present invention provides a method of generating side information by correcting a motion field error in distributed video coding (DVC) capable of performing a motion compensation by shifting the position of a motion compensation block by an error of a motion field in estimating a current frame from the past and future frames in DVC, to thereby increase the accuracy of the current frame estimation results, and a DVC decoder using the same.

According to an aspect of the present invention, there is provided a method of generating side information by correcting an error of a motion field in DVC, including: extracting a motion field based on blocks between a future frame and a past frame; shifting the position of a motion compensation block by an error of the motion field; and performing motion compensation based on the position-shifted motion compensation block.

In shifting the position of the motion compensation block, the motion compensation block may be shifted to allow the motion field to be located at the center of a motion compensation block of a current frame.

According to another aspect of the present invention, there is provided a DVC decoder including: a video merging module transferring previously decoded frames to an information generating module; and a side information generation module extracting a motion field based on blocks between a future frame and a past frame which have been transferred from the video merging module, shifting the position of a motion compensation block by an error of the motion field, and performing motion compensation based on the position-shifted motion compensation block.

The side information generation module may shift the position of the motion compensation block such that the motion field is located at the center of the motion compensation block of a current frame.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a general conceptual view of distributed video coding (DVC);

FIG. 2 is a view for explaining a motion field error in DVC;

FIG. 3 is a view for explaining correction of an error of a motion field in DVC according to an exemplary embodiment of the present invention; and

FIG. 4 is a flow chart illustrating the process of generating side information by correcting the error of the motion field in DVC according to an exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

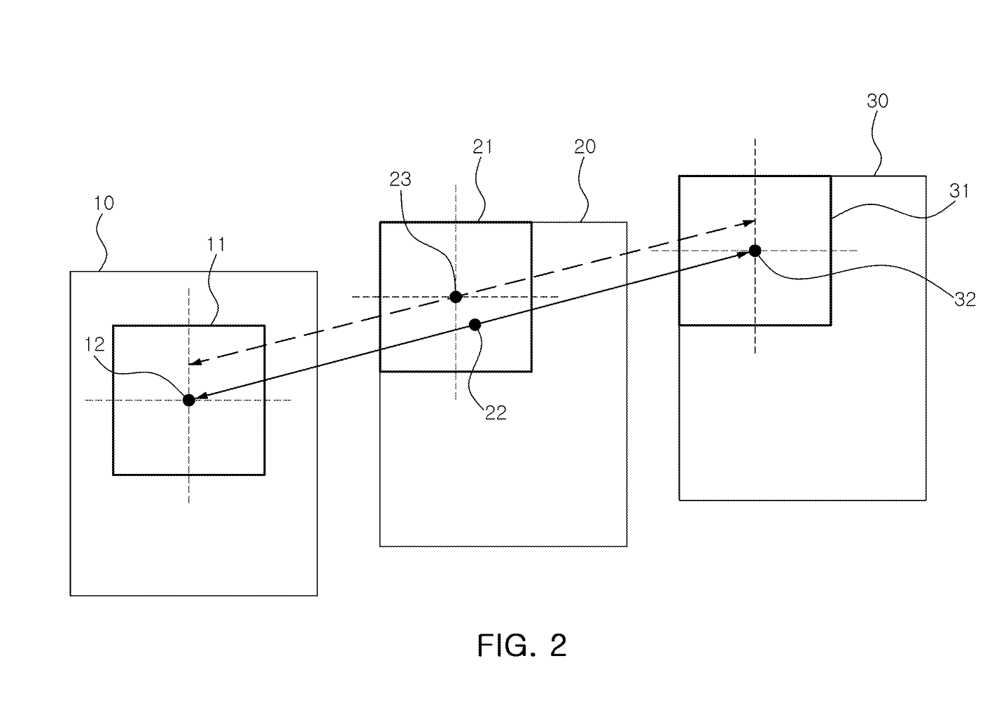

FIG. 2 is a view for explaining a motion field error in DVC.

As shown in FIG. 2, when a motion field is acquired based on blocks between a future frame 30 closest to a current frame and a past frame 10 closest to the current frame, it passes through a point 22 of a block matched to the current frame 20. In other words, the obtained motion field is not such a motion field that passes through the center 23 of a corresponding motion compensation block 21.

In this case, however, for a motion compensation of the corresponding motion compensation block 21, motion information of the center 23 of the corresponding block 21 is required. If the acquired motion field is used as it is, it means that the motion compensation is performed in submission to the involvement of an error in a motion vector, ending with an error in estimation of the current frame.

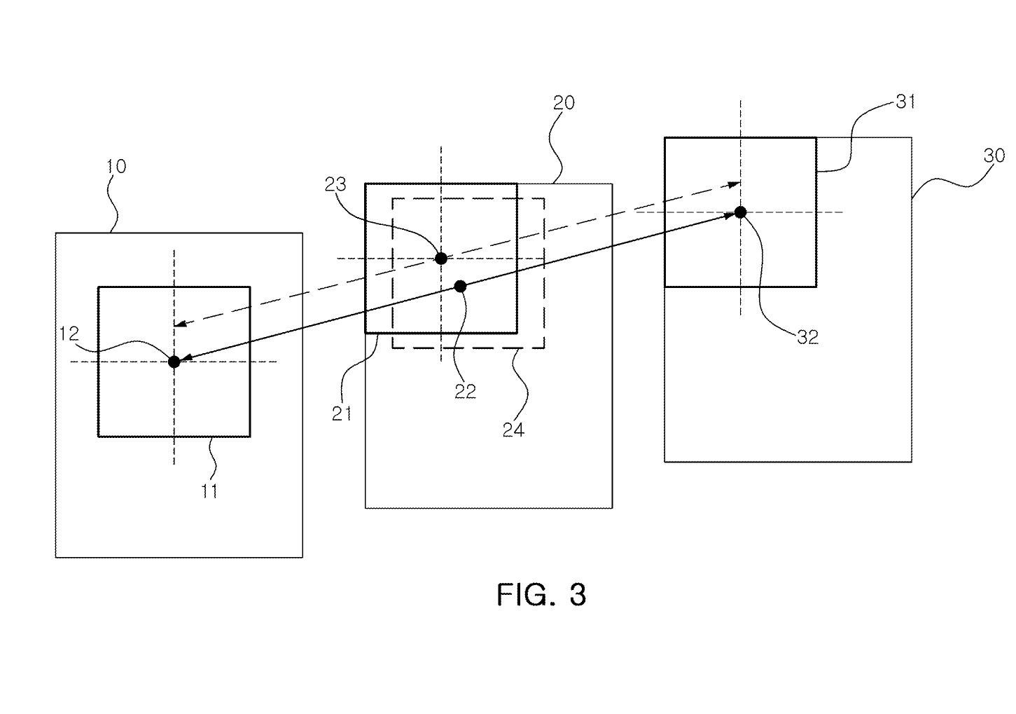

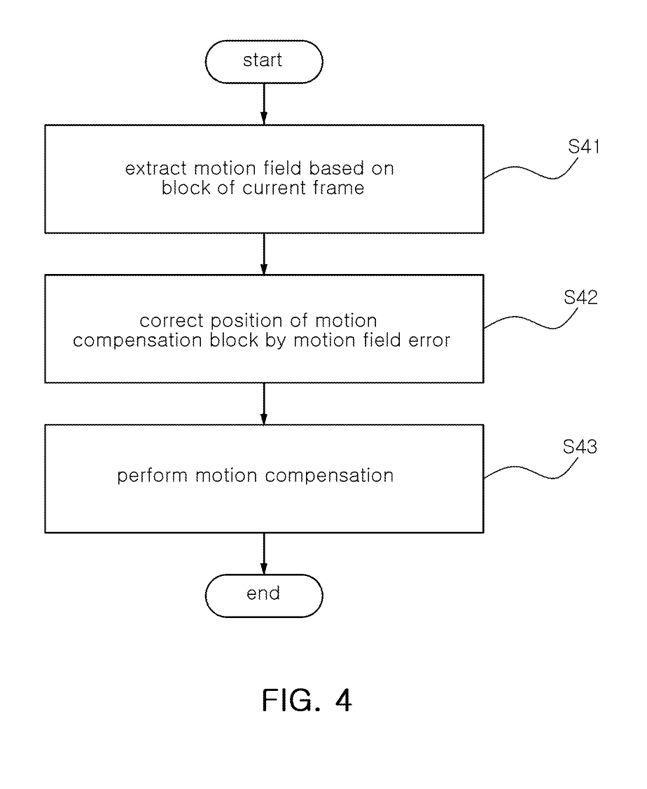

In an exemplary embodiment of the present invention, in order to correct an error of the motion field, the position of a motion compensation block is corrected as follows. The present invention will now be described in detail with reference to FIGS. 3 and 4.

FIG. 3 is a view for explaining a correction of an error of a motion field in DVC according to an exemplary embodiment of the present invention.

In the present exemplary embodiment, a motion field is acquired based on blocks between the future frame 30 closest to the current frame 20 and the past frame 10 closest to the current frame 20, the position of the motion compensation block is shifted such that the motion field obtained from the current frame 20 comes to the center of the motion compensation block, and motion compensation is then performed.

Referring to the related art as mentioned above, motion compensation is performed on the assumption that the acquired motion field is a motion field with respect to the center 23 of the block 21 corresponding to the solid line of the current frame 20. Comparatively, however, in the present invention, the motion compensation block is shifted to the block 24 corresponding to the dotted line. Namely, the motion compensation block is corrected by the error of the motion field to make the motion field come to the center of the motion compensation block, and motion compensation is then performed. Accordingly, the motion compensation can be performed without a motion field error, so the current frame can be accurately estimated.

FIG. 4 is a flow chart illustrating the process of generating side information by correcting the error of the motion field in DVC according to an exemplary embodiment of the present invention.

First, a motion field is extracted based on the blocks between the future frame closest to the current frame and the past frame closest to the current frame (S41). Extracting the motion field based on the future frame and the past frame can be made by a conventional motion field extraction method widely known in the art to which the present invention pertains, so a detailed description thereof will be omitted.

Next, the position of the motion compensation block is shifted by an error of the acquired motion field to correct the error of the motion field (S42).

Then, motion compensation is performed based on the position-shifted motion compensation block (S43).

As described above, the accurate current frame can be estimated by generating the side information by correcting the error of the motion field.

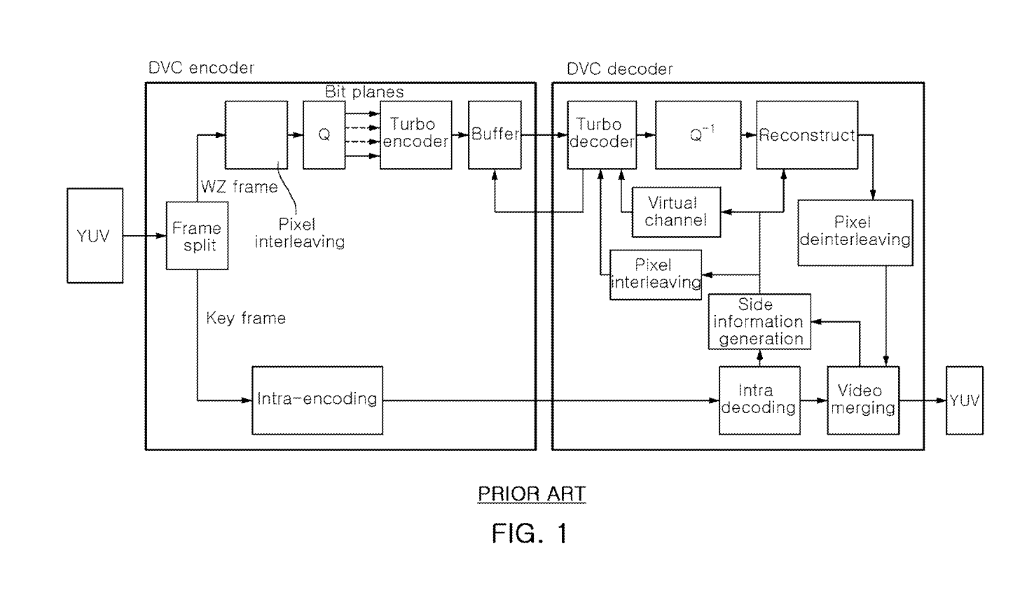

The side information generating process as stated above is performed by a side information generation module of a DVC decoder illustrated in FIG. 1. A video merging module stores previously decoded frames and then transfers the stored decoded frames to the side information generation module. Upon receipt of them, the side information generation module estimates the current frame from the future and past frames as described above.

As set forth above, according to exemplary embodiments of the invention, in estimating a current frame from the past and future frames without information about the current frame in DVC, the position of a motion compensation block is shifted by an error of a motion field, and motion compensation is then performed to thereby increase the accuracy of the current frame estimation results. Accordingly, the bit rate of the DVC can be reduced, and accordingly, a compression performance can be enhanced.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of generating side information by correcting a motion field error in distributed video coding (DVC), the method comprising:
extracting a motion field based on blocks between a future frame and a past frame;
shifting the position of a motion compensation block by an error of the motion field; and
performing motion compensation based on the position-shifted motion compensation block.

2. The method of claim 1, wherein, in shifting the position of the motion compensation block, the motion compensation block is shifted to allow the motion field to be located at the center of a motion compensation block of a current frame.

3. A distributed video coding (DVC) decoder comprising:
a video merging module transferring previously decoded frames to an information generating module; and
a side information generation module extracting a motion field based on blocks between a future frame and a past frame which have been transferred from the video merging module, shifting the position of a motion compensation block by an error of the motion field, and performing motion compensation based on the position-shifted motion compensation block.

4. The DVC decoder of claim 3, wherein the side information generation module shifts the position of the motion compensation block such that the motion field is located at the center of the motion compensation block of a current frame.
